(19) United States
(12) Patent Application Publication
(10) Pub. No.: US 2026/0221305 A1
(43) Pub. Date: Jul. 30, 2026

(54) LIQUID SCINTILLATOR TRANSDUCER-POWERED NUCLEAR VOLTAIC SYSTEM

(71) Applicant: NIMA GOLSHARIFI, LONDON (GB)

(72) Inventor: NIMA GOLSHARIFI, LONDON (GB)

(73) Assignee: NUBATT PTE. LTD., Singapore (SG)

(21) Appl. No.: 19/558,443

(22) Filed: Mar. 6, 2026

(30) Foreign Application Priority Data
Mar. 11, 2025 (SG) SG10202500617Q

(51) Int. Cl. G21H 1/04

(52) U.S. Cl. CPC G21H 1/04

(57) ABSTRACT

A nuclear voltaic power source utilizing liquid scintillator transducer media combined with radioisotopes for electrical power generation. The system employs a diverse range of liquid scintillator materials including liquid noble gas scintillators (LXe, LKr, LAr, LNe, LHe), organic liquid scintillators (PC+PPO, LAB+PPO, toluene+PPO, xylene+PPO, PXE+PPO), cerium-doped silicate liquids, ionic liquids with scintillating solutes, and nanoparticle-enhanced suspensions incorporating quantum dots or metal-organic frameworks. The scintillators convert ionizing radiation into photons, which are absorbed by wide bandgap semiconductors (SiC, GaN, AlN, diamond, B4C, AlGaN) matched to the scintillator emission wavelength. Wavelength shifters optimize spectral matching. Liquid scintillators provide inherent self-healing against radiation damage. Multiple cells with different scintillator types may be connected in series-parallel arrays for optimized power output. The system is scalable for space, medical, and remote power applications.

### CROSS-REFERENCE TO RELATED APPLICATIONS

This application claims the benefit of priority to Singapore Patent Application No. 10202500617Q, filed Mar. 11, 2025, entitled “Nuclear Voltaic System,” the entire disclosure of which is hereby incorporated by reference.

### FIELD OF THE INVENTION

The present invention relates to nuclear power generation, and more specifically to a nuclear voltaic power source that utilizes liquid scintillator transducer media in combination with radioisotopes to convert nuclear radiation energy into electrical power. The liquid scintillator transducers encompass a diverse range of materials including liquid noble gas scintillators, organic liquid scintillators, cerium-doped silicate liquids, ionic liquids with scintillating solutes, and nanoparticle-enhanced scintillator suspensions. These transducers convert radiation energy into photons through optimized scintillation processes, and the photons are subsequently absorbed by wide bandgap semiconductors to generate electrical current.

### BACKGROUND OF THE INVENTION

Traditional nuclear voltaic systems have relied primarily on solid-state semiconductor materials for direct radiation-to-electricity conversion. While effective, solid-state materials present limitations including radiation-induced lattice damage, limited energy conversion efficiencies, and degraded performance over extended operational lifetimes in high-radiation environments. Solid crystalline semiconductors can suffer from displacement damage, point defects, and amorphization when exposed to high-energy particles, progressively reducing their charge carrier mobility and photovoltaic efficiency.

Liquid scintillator transducers address these fundamental limitations. The fluid nature of liquid scintillators provides inherent self-healing properties, as radiation-induced molecular damage is continuously mitigated by the dynamic rearrangement of molecules in the liquid phase. Unlike solid-state materials where lattice defects accumulate irreversibly, liquid scintillators maintain their scintillation performance over extended periods of radiation exposure.

Furthermore, liquid scintillators offer a two-stage energy conversion pathway (radiation to photons, then photons to electricity) that can achieve higher overall efficiency than direct radiation-to-electricity conversion in certain configurations. The intermediate photon generation step allows optimization of both the scintillation process and the photovoltaic conversion independently, enabling systematic matching of scintillator emission wavelengths to semiconductor absorption characteristics through wavelength shifting and bandgap engineering.

### SUMMARY OF THE INVENTION

The present invention provides a nuclear voltaic power source comprising: (a) at least one radioisotope emitting alpha, beta, or gamma radiation; (b) at least one liquid scintillator transducer medium selected from the group consisting of liquid noble gas scintillators, organic liquid scintillators, cerium-doped silicate liquids, ionic liquids with scintillating solutes, and nanoparticle-enhanced scintillator suspensions; (c) at least one wide bandgap semiconductor converter for absorbing the scintillation photons and converting them into electron-hole pairs; (d) electrical contacts for charge extraction; and (e) a containment structure ensuring safety, radiation shielding, and operational efficiency.

The system optionally incorporates wavelength shifters for spectral matching between scintillator emission and semiconductor absorption, nanostructured materials for enhanced photon management, self-healing and adaptive material properties inherent to liquid scintillators, and thermal management systems for maintaining optimal scintillation conditions across the diverse range of operating temperatures required by the different scintillator classes.

### BRIEF DESCRIPTION OF THE DRAWINGS

FIG. 1 is a cross-sectional view of a spherical liquid scintillator nuclear voltaic device.

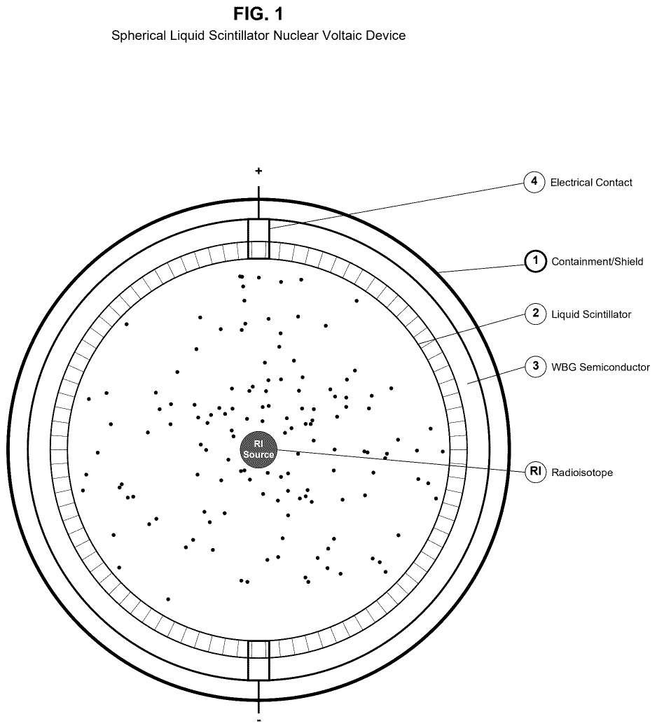

FIG. 2 is a schematic of the scintillation conversion mechanism showing radiation-to-photon-to-electricity pathway.

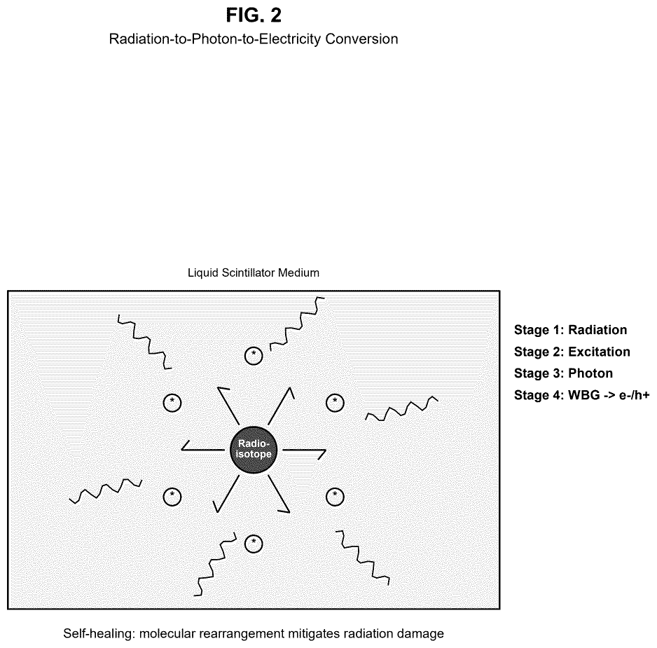

FIG. 3 is a vertical flowchart of the three-stage energy conversion process.

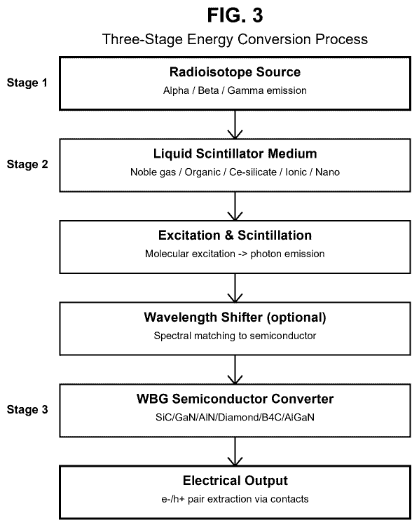

FIG. 4 is a table of liquid noble gas scintillator properties.

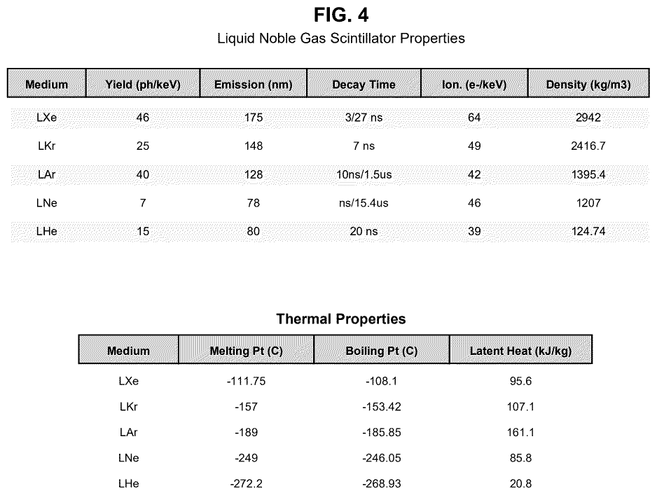

FIG. 5 is a table of organic liquid scintillator properties.

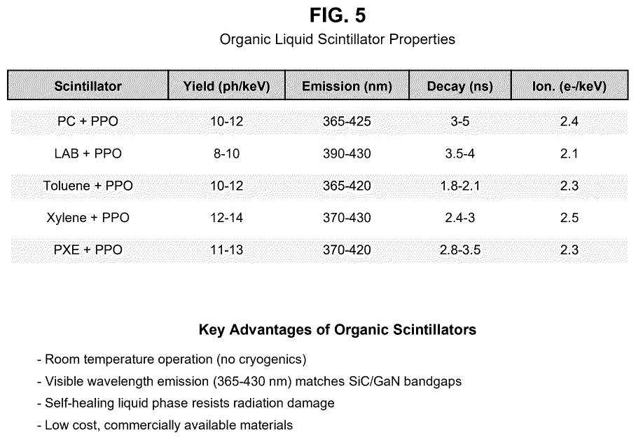

FIG. 6 is a table of advanced scintillator material properties.

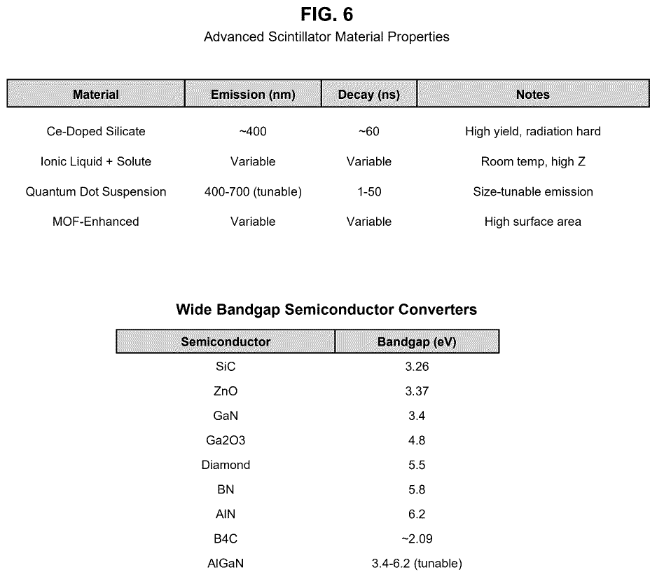

FIG. 7 is a scintillator emission wavelength vs WBG semiconductor bandgap matching diagram.

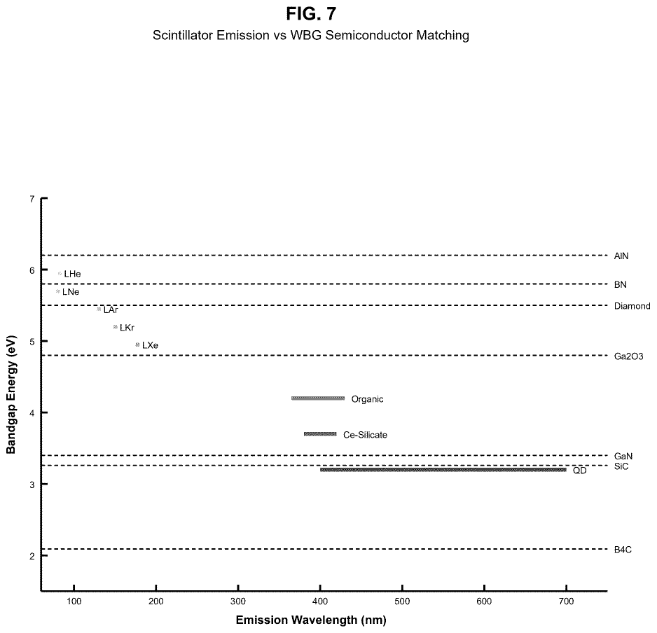

FIG. 8 is a parts reference table.

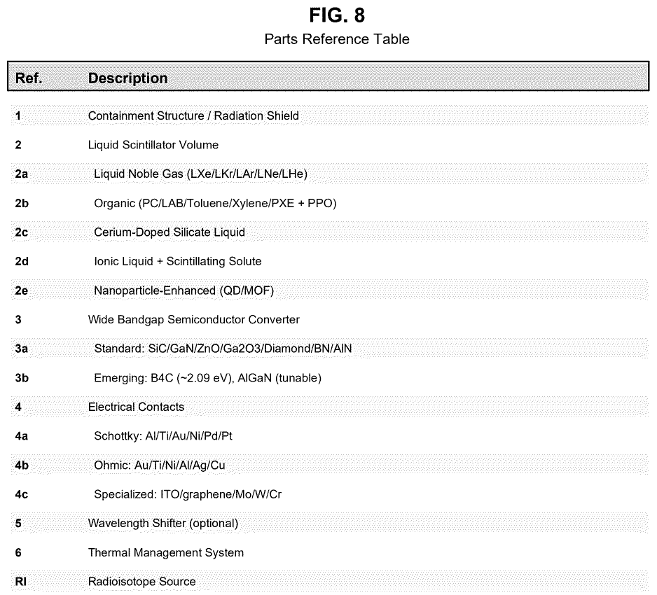

FIG. 9 is a cylindrical device configuration cross-section.

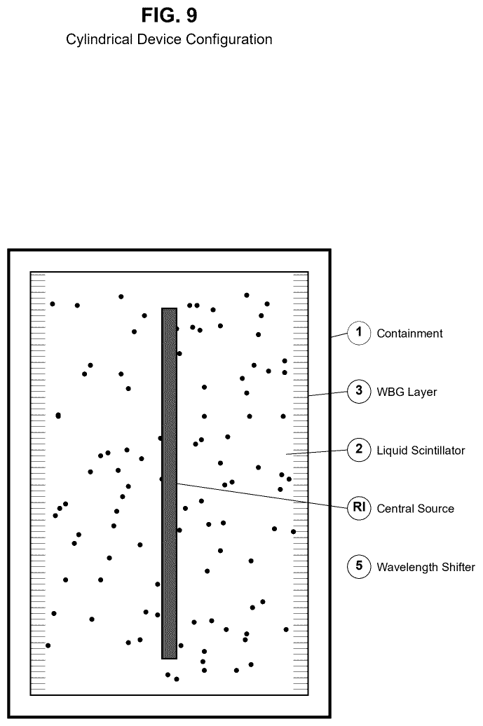

FIG. 10 is a multi-scintillator hybrid cell array schematic.

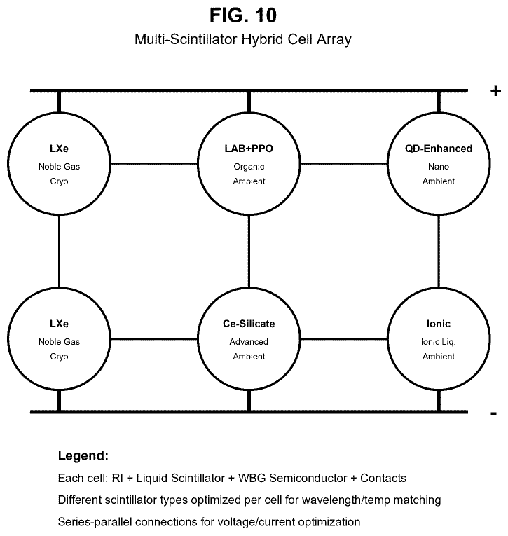

### DETAILED DESCRIPTION OF THE INVENTION

### Liquid Noble Gas Scintillators

The system may utilize liquid noble gas scintillators as the transducer medium. Liquid noble gases exhibit excellent scintillation properties with high photon yields and fast response times. When ionizing radiation interacts with the liquid noble gas, it excites atoms and creates excited-state dimers (excimers) that emit vacuum ultraviolet photons upon relaxation to the repulsive ground state. The liquid noble gas scintillators include: liquid xenon (LXe) with a scintillation yield of approximately 46 photons/keV at 175 nm emission; liquid krypton (LKr) with approximately 25 photons/keV at 148 nm; liquid argon (LAr) with approximately 40 photons/keV at 128 nm; liquid neon (LNe) with approximately 7 photons/keV at 78 nm; and liquid helium (LHe) with approximately 15 photons/keV at 80 nm.

Each liquid noble gas requires cryogenic temperatures for operation. Liquid xenon operates between −111.75 and −108.1 degrees Celsius with a density of 2942 kg/m³. Liquid krypton operates between −157 and −153.42 degrees Celsius with a density of 2416.7 kg/m³. Liquid argon operates between −189 and −185.85 degrees Celsius with a density of 1395.4 kg/m³. Liquid neon operates between −249 and −246.05 degrees Celsius with a density of 1207 kg/m³. Liquid helium operates between −272.2 and −268.93 degrees Celsius with a density of 124.74 kg/m3.

### Organic Liquid Scintillators

The system may alternatively utilize organic liquid scintillators based on aromatic hydrocarbons dissolved in suitable solvents. These scintillators operate at or near room temperature and convert ionizing radiation into visible-range photons through fluorescence of the aromatic molecules. The organic liquid scintillators include: pseudocumene (PC) with PPO, yielding 10-12 photons/keV at 365-425 nm with 3-5 ns decay time; linear alkylbenzene (LAB) with PPO, yielding 8-10 photons/keV at 390-430 nm with 3.5-4 ns decay time; toluene with PPO, yielding 10-12 photons/keV at 365-420 nm with 1.8-2.1 ns decay time; xylene with PPO, yielding 12-14 photons/keV at 370-430 nm with 2.4-3 ns decay time; and phenylxylylethane (PXE) with PPO, yielding 11-13 photons/keV at 370-420 nm with 2.8-3.5 ns decay time.

Organic liquid scintillators offer significant advantages for room-temperature nuclear voltaic applications, eliminating the need for cryogenic systems. The visible-wavelength emission of organic scintillators enables the use of lower-bandgap semiconductors such as SiC and GaN, which are more mature and commercially available than the VUV-responsive materials required for noble gas scintillators.

### Cerium-Doped Silicate Liquids

Cerium-doped silicate scintillators provide high light yield with excellent radiation hardness. The cerium ions act as activators, providing efficient energy transfer pathways that enhance the scintillation process. These scintillators emit at approximately 400 nm with a decay time of approximately 60 nanoseconds. The cerium doping concentration may be optimized to maximize scintillation yield while maintaining optical transparency of the liquid medium.

Ionic Liquids with Scintillating Solutes

Ionic liquids are molten salts that remain liquid at room temperature, consisting entirely of ions. When doped with scintillating solutes, ionic liquids offer unique properties for radiation absorption and energy conversion. The ionic nature of the medium provides high radiation stopping power due to the high charge density, while the scintillating solutes convert the deposited energy into photons. Ionic liquid scintillators offer variable emission wavelengths and decay times depending on the specific ionic liquid and scintillating solute combination selected.

### Nanoparticle-Enhanced Scintillators

The incorporation of nanoparticles such as quantum dots or metal-organic frameworks (MOFs) into liquid scintillator media can enhance scintillation properties. Quantum dots offer tunable emission wavelengths between 400 and 700 nm based on their size and composition, allowing precise matching of the emission spectrum to the semiconductor absorption characteristics. MOFs provide high surface area structures that can enhance radiation interaction and energy transfer. The nanoparticle concentration is optimized to maximize photon production while maintaining optical clarity of the scintillator medium.

### Wavelength Shifting and Spectral Matching

The system may incorporate wavelength shifters to optimize the spectral match between scintillator emission and semiconductor absorption. Wavelength shifting compounds absorb photons at the scintillator emission wavelength and re-emit at a wavelength more closely matched to the semiconductor bandgap energy. This spectral engineering approach maximizes the photon-to-electron conversion efficiency and reduces thermalization losses in the semiconductor converter.

### Self-Healing and Adaptive Properties

A key advantage of liquid scintillator transducers is their inherent self-healing capability. Unlike solid-state materials where radiation-induced lattice damage accumulates over time, the fluid nature of liquid scintillators allows continuous molecular rearrangement that mitigates radiation damage. This self-healing property significantly extends the operational lifespan of the nuclear voltaic system, particularly in high-radiation environments where solid-state systems would suffer progressive degradation.

### Wide Bandgap Semiconductor Converters

The wide bandgap semiconductor converter is selected to match the emission wavelength of the chosen liquid scintillator. Suitable materials include: silicon carbide (SiC, bandgap 3.26 eV), zinc oxide (ZnO, bandgap 3.37 eV), gallium nitride (GaN, bandgap 3.4 eV), gallium oxide (Ga2O3, bandgap 4.8 eV), diamond (bandgap 5.5 eV), boron nitride (BN, bandgap 5.8 eV), aluminum nitride (AlN, bandgap 6.2 eV), boron carbide (B4C, bandgap approximately 2.09 eV), and aluminum gallium nitride (AlGaN, tunable bandgap 3.4-6.2 eV). The selection is guided by matching the semiconductor bandgap to the scintillator emission energy to minimize thermalization losses.

### Electrical Contacts

Electrical contacts are provided for extracting photogenerated charge carriers. Schottky diode contacts may be formed from aluminum (4.28 eV), titanium (4.33 eV), gold (5.1 eV), nickel (5.15 eV), palladium (5.6 eV), or platinum (5.65 eV). Ohmic contacts may employ gold, titanium, nickel, aluminum, silver, or copper. Specialized contacts including ITO, graphene, molybdenum, tungsten, and chromium may be used for transparent or application-specific configurations.

### Containment and Device Configurations

The containment structure is designed to maintain the liquid scintillator in its operational state while providing radiation shielding and structural integrity. For noble gas scintillators, the containment includes cryogenic thermal management. For organic and ionic liquid scintillators, the containment maintains appropriate temperature conditions near ambient. The device may be configured in spherical, cylindrical, or planar geometries. The spherical geometry is preferred for maximizing photon capture angle by the semiconductor layer.

What is claimed is:

1. A nuclear voltaic power source comprising:
(a) at least one radioisotope configured to emit ionizing radiation;
(b) at least one liquid scintillator transducer medium selected from the group consisting of liquid noble gas scintillators, organic liquid scintillators, cerium-doped silicate liquids, ionic liquids with scintillating solutes, and nanoparticle-enhanced scintillator suspensions, the liquid scintillator transducer medium converting the ionizing radiation into scintillation photons;
(c) at least one wide bandgap semiconductor converter disposed to receive the scintillation photons and convert them into electron-hole pairs;
(d) electrical contacts for extracting current from the wide bandgap semiconductor converter; and
(e) a containment structure housing the radioisotope and liquid scintillator transducer medium.

2. The nuclear voltaic power source of claim 1, wherein the liquid scintillator transducer medium is a liquid noble gas scintillator selected from the group consisting of liquid xenon, liquid krypton, liquid argon, liquid neon, and liquid helium.

3. The nuclear voltaic power source of claim 1, wherein the liquid scintillator transducer medium is an organic liquid scintillator selected from the group consisting of pseudocumene with PPO, linear alkylbenzene with PPO, toluene with PPO, xylene with PPO, and phenylxylylethane with PPO.

4. The nuclear voltaic power source of claim 1, wherein the liquid scintillator transducer medium is a cerium-doped silicate liquid emitting at approximately 400 nm.

5. The nuclear voltaic power source of claim 1, wherein the liquid scintillator transducer medium is an ionic liquid doped with a scintillating solute.

6. The nuclear voltaic power source of claim 1, wherein the liquid scintillator transducer medium comprises nanoparticles selected from quantum dots and metal-organic frameworks dispersed in a liquid scintillator host.

7. The nuclear voltaic power source of claim 6, wherein the quantum dots have tunable emission wavelengths between 400 and 700 nm based on quantum dot size and composition.

8. The nuclear voltaic power source of claim 1, wherein the wide bandgap semiconductor converter is selected from the group consisting of silicon carbide, zinc oxide, gallium nitride, gallium oxide, diamond, boron nitride, aluminum nitride, boron carbide, and aluminum gallium nitride.

9. The nuclear voltaic power source of claim 1, further comprising a wavelength shifter disposed between the liquid scintillator transducer medium and the wide bandgap semiconductor converter for spectral matching of scintillator emission to semiconductor absorption.

10. The nuclear voltaic power source of claim 1, wherein the liquid scintillator transducer medium exhibits self-healing properties wherein radiation-induced molecular damage is mitigated by dynamic molecular rearrangement in the liquid phase.

11. A nuclear voltaic power source comprising:
(a) at least one radioisotope;
(b) an organic liquid scintillator transducer medium based on an aromatic hydrocarbon dissolved in a solvent, the organic liquid scintillator converting ionizing radiation into visible-wavelength photons in the range of 365 to 430 nm;
(c) at least one wide bandgap semiconductor converter having a bandgap energy matched to the visible-wavelength emission;
(d) electrical contacts; and
(e) a containment structure maintaining the organic liquid scintillator at a temperature suitable for liquid-phase operation.

12. The nuclear voltaic power source of claim 11, wherein the aromatic hydrocarbon is selected from pseudocumene, linear alkylbenzene, toluene, xylene, and phenylxylylethane, and the solvent includes 2,5-diphenyloxazole (PPO) as a primary fluor.

13. The nuclear voltaic power source of claim 11, wherein the wide bandgap semiconductor converter is silicon carbide or gallium nitride having a bandgap energy between 3.26 and 3.4 eV.

14. The nuclear voltaic power source of claim 11, wherein the organic liquid scintillator operates at ambient temperature without cryogenic cooling.

15. The nuclear voltaic power source of claim 11, wherein the organic liquid scintillator has a scintillation yield of at least 8 photons per keV of deposited energy.

16. A method of converting nuclear radiation energy into electrical power using a liquid scintillator transducer, the method comprising:
(a) providing a liquid scintillator transducer medium in a containment structure;
(b) exposing the liquid scintillator transducer medium to ionizing radiation from at least one radioisotope;
(c) converting the ionizing radiation into scintillation photons within the liquid scintillator transducer medium;
(d) absorbing the scintillation photons in a wide bandgap semiconductor converter to generate electron-hole pairs;
(e) extracting electrical current through electrical contacts; and
(f) selecting the wide bandgap semiconductor converter based on spectral matching of its bandgap energy to the emission wavelength of the liquid scintillator transducer medium.

17. The method of claim 16, further comprising interposing a wavelength shifter between the liquid scintillator transducer medium and the wide bandgap semiconductor converter to optimize spectral matching.

18. The method of claim 16, wherein step (a) comprises maintaining a cryogenic liquid noble gas at a temperature below its boiling point.

19. The method of claim 16, wherein step (a) comprises providing an organic liquid scintillator at ambient temperature.

20. The method of claim 16, further comprising enhancing the liquid scintillator with nanoparticles selected from quantum dots and metal-organic frameworks.

21. A nuclear voltaic power source comprising:
a containment structure;
at least one radioisotope within the containment structure;
a nanoparticle-enhanced liquid scintillator medium within the containment structure, the medium comprising a liquid scintillator host and nanoparticles selected from quantum dots, metal-organic frameworks, and nanocrystals dispersed therein, the nanoparticles providing enhanced radiation interaction and tunable photon emission;
a wide bandgap semiconductor converter disposed to receive the photons emitted by the nanoparticle-enhanced scintillator and convert them into electron-hole pairs; and
electrical contacts for current extraction.

22. The nuclear voltaic power source of claim 21, wherein the quantum dots have size-tunable emission in the range of 400 to 700 nm.

23. The nuclear voltaic power source of claim 21, wherein the nanoparticle concentration is optimized to maximize photon production while maintaining optical transparency of the scintillator medium.

24. The nuclear voltaic power source of claim 21, wherein the containment structure has a spherical geometry and the wide bandgap semiconductor converter lines the interior surface.

25. The nuclear voltaic power source of claim 21, wherein the liquid scintillator host is selected from organic liquid scintillators and ionic liquids.

26. A nuclear voltaic power system comprising:
a plurality of nuclear voltaic power cells, wherein at least two cells employ different liquid scintillator transducer media selected from the group consisting of liquid noble gas scintillators, organic liquid scintillators, cerium-doped silicate liquids, ionic liquids with scintillating solutes, and nanoparticle-enhanced scintillator suspensions;
each cell further comprising at least one radioisotope, a wide bandgap semiconductor converter matched to the emission wavelength of its respective liquid scintillator, electrical contacts, and a containment structure; and
an electrical interconnection connecting the plurality of cells in at least one of a series and a parallel configuration.

27. The nuclear voltaic power system of claim 26, wherein a first cell employs a liquid noble gas scintillator with a VUV-responsive wide bandgap semiconductor and a second cell employs an organic liquid scintillator with a visible-light-responsive wide bandgap semiconductor.

28. The nuclear voltaic power system of claim 26, wherein the wide bandgap semiconductor converter in each cell is independently selected to minimize thermalization losses based on the specific scintillator emission wavelength of that cell.

29. The nuclear voltaic power system of claim 26, further comprising at least one cell incorporating a wavelength shifter for spectral matching.

30. The nuclear voltaic power system of claim 26, wherein the liquid scintillator transducer media in at least one cell exhibits self-healing properties providing extended operational lifetime under sustained radiation exposure.
